(19) United States
(12) Patent Application Publication
(10) Pub. No.: US 2007/0006279 A1
(43) Pub. Date: Jan. 4, 2007

(54) Active new password entry dialog with compact visual indication of adherence to password policy

(75) Inventors: Michael K. Brown, Kitchener (CA); Michael S. Brown, Waterloo (CA); Neil P. Adams, Waterloo (CA); Herbert A. Little, Waterloo (CA); Michael E. McCallum, Elmira (CA); Dinah L.M. Davis, Waterloo (CA)

Correspondence Address: NIXON & VANDERHYE, PC, 901 NORTH GLEBE ROAD, 11TH FLOOR, ARLINGTON, VA, 22203, US

(73) Assignee: Research in Motion Limited, Waterloo (CA)

(21) Appl. No.: 11/171,477

(22) Filed: Jul. 1, 2005

(51) Int. Cl. H04L 9/00

(52) U.S. Cl. 726/1

(57) ABSTRACT

An active new password entry dialog provides a compact visual indication of adherence to password policies. A visual indication of progress towards meeting all applicable password policies is included in the display and updated as new password characters are being entered. A visual hint associated with at least one applicable password policy that has not yet been satisfied is also included in the display. An ability to obtain more detailed comprehensive password policy information is also permitted upon user command (e.g., including an indication whether each password policy has yet been met or unmet). Preferably the displayed hint and associated applicable password policy not yet satisfied is randomly changed during entry of a new password (e.g., upon the entry of each new password character).

### BACKGROUND

1. Technical Field

This application generally relates to an active new password entry dialog with compact visual indication of adherence to password policy. It may be used with mobile wireless communication devices having a limited visual display area.

2. Related Art

Computer-based electronic devices of many sorts now require passwords for authorized operation. For ensuring an appropriate level of security, such passwords should be changed frequently.

The need to enter new passwords is especially present for mobile wireless communication devices which may be lost, stolen, misplaced or the like. If such new password entry routines require communication with a base station or the like, then communication bandwidth is also required for new password entry processes. Conservation of such bandwidth for more useful communication payload is, of course, desirable. Furthermore, small handheld mobile wireless communication devices often have limited numbers of keys and limited display area.

If a user needs to set a new password, often he/she has to conform to some password policies that the user's employer has determined.

A typical current problem is that the user enters a password, clicks OK, and only then is the password checked against the required policies. If it passes, all is well. If it fails, then a dialog may pop up explaining what policy or part of a policy the password failed to satisfy. Then the user must start all over again.

This is not an ideal solution. It would be better if the user could be alerted while setting the password, to let him/her know how they are doing. This would make the user experience much better.

There are at least two earlier products that address some aspects of this problem:
1) Entrust S/MIME Client has a dialog box for setting a password. In this dialog box all of the password policies are listed and an indication is provided as to whether or not the new password being entered is meeting such policies.
2) PGP Keys Client, when creating a PGP key, requires the user to set a password. While the user is typing a password, a progress-like bar is displayed at the bottom of the screen which indicates the estimated security strength of the new password.

The Entrust approach puts a lot of information all on one screen. A small handheld mobile wireless device typically does not have sufficient display area available for this approach. The PGP approach does use a more compact higher level progress-like bar—but only one that refers to the estimated security strength of the password being entered. It has nothing to do with password policy.

### BRIEF DESCRIPTION OF THE DRAWINGS

These and other objects and advantages will be better understood and appreciated in conjunction with the following detailed description of exemplary embodiments taken together with the accompanying drawings, in which:

FIG. 1 is an overall system wide schematic view of an exemplary wireless email communication system incorporating a mobile wireless communication device with duress password protection in accordance with one exemplary embodiment;

FIG. 2 is an abbreviated schematic diagram of hardware included within an exemplary mobile wireless communication device;

FIG. 3 is an exemplary abbreviated schematic flow chart of computer software (i.e., program logic) that may be utilized in the device of FIG. 2 providing active new password entry dialog with compact visual indication of adherence to password policy;

FIG. 4 is an exemplary format for an active new password entry dialog screen; and

FIG. 5 is an exemplary format for a more detailed pop-up dialog with more detailed password policy information.

### DETAILED DESCRIPTION OF EXEMPLARY EMBODIMENTS

In one exemplary embodiment we now add a progress bar to the screen where a new password is being entered. To overcome the problem of limited display area, we provide a progress bar with rolling hints that summarize useful feedback information into a compact visual display. This embodiment uses applicable password policies to display progress and allows the user to find out more information about the policies and the new password's compliance with such policies.

Suppose a password has a series of 5 password policies that must be met. As a user enters a password, our present exemplary embodiment is constantly checking (e.g., dynamically after each character has been entered) whether the user has yet fulfilled any policy requirements. If the user does newly satisfy a policy, the progress bar filling is increased. If the user has met 3 of the 5 requirements, then 60% of the bar will be filled. Only when the bar reaches 100% is the user allowed to click “OK” to close the dialog box and set the password.

But suppose a user has entered a password and the bar is stuck at 60%. How does the user figure out what policies have not yet been met? First one can display a hint underneath the progress bar describing one of the policies that has not yet been met. Preferably one of the remaining policies is chosen at random (rather than just in some predetermined order) to better insure that passwords on different devices are as different as possible. So, for example, if the user has not yet put a numerical character into the password, the display under the progress bar might read “MUST INCLUDE A NUMBER.” In addition, in our present exemplary embodiment, the user can select the progress bar which will cause another dialog box to pop up listing all password policies along with an indication as to whether each has yet been fulfilled.

As a further optional possibility, instead of having a fixed progress bar (i.e., always present) in the dialog box, the progress bar could pop up (like tips or suggestion pop ups) below the password edit box while the user is typing. This makes the display a little more dynamic. The user gets more feedback on the quality of his/her password and on the current password policies.

Our new arrangement may be embodied in hardware, software or a combination of hardware and software. It also provides a method for providing active new password entry dialog with compact visual indication of adherence to password policy. The exemplary embodiment is realized, at least in part, by executable computer program code which may be embodied in physical program memory media.

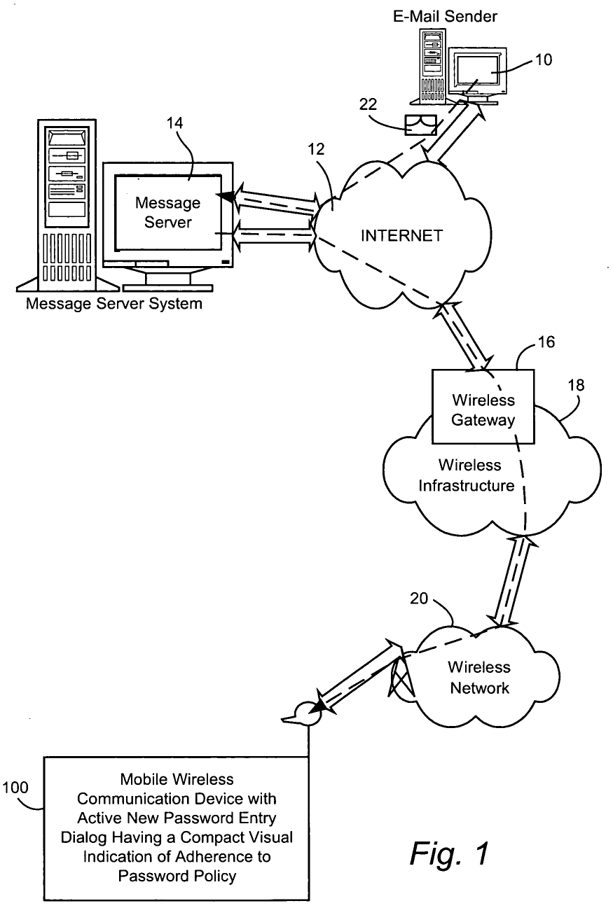

FIG. 1 is an overview of an exemplary communication system in which a wireless communication device 100 may be used in accordance with this exemplary embodiment. One skilled in the art will appreciate that there may be hundreds of different system topologies. There may also be many message senders and recipients. The simple exemplary system shown in FIG. 1 is for illustrative purposes only, and shows perhaps the currently most prevalent Internet email environment.

FIG. 1 shows an email sender 10, the Internet 12, a message server system 14, a wireless gateway 16, wireless infrastructure 18, a wireless network 20 and a mobile communication device 100.

An email sender 10 may, for example, be connected to an ISP (Internet Service Provider) on which a user of the system has an account, located within a company, possibly connected to a local area network (LAN), and connected to the Internet 12, or connected to the Internet 12 through a large ASP (application service provider) such as America Online™ (AOL). Those skilled in the art will appreciate that the systems shown in FIG. 1 may instead by connected to a wide area network (WAN) other than the Internet, although email transfers are commonly accomplished through Internet-connected arrangements as shown in FIG. 1.

The message server 14 may be implemented, for example, on a network computer within the firewall of a corporation, a computer within an ISP or ASP system or the like, and acts as the main interface for email exchange over the Internet 12. Although other messaging systems might not require a message server system 14, a mobile device 100 configured for receiving and possibly sending email will normally be associated with an account on a message server. Perhaps the two most common message servers are Microsoft Exchange™ and Lotus Domino™. These products are often used in conjunction with Internet mail routers that route and deliver mail. These intermediate components are not shown in FIG. 1, as they do not directly play a role in the system described below. Message servers such as server 14 typically extend beyond just email sending and receiving; they also include dynamic database storage engines that have predefined database formats for data like calendars, to-do lists, task lists, email and documentation.

The wireless gateway 16 and infrastructure 18 provide a link between the Internet 12 and wireless network 20. The wireless infrastructure 18 determines the most likely network for locating a given user and tracks the users as they roam between countries or networks. A message is then delivered to the mobile device 100 via wireless transmission, typically at a radio frequency (RF), from a base station in the wireless network 20 to the mobile device 100. The particular network 20 may be virtually any wireless network over which messages may be exchanged with a mobile communication device.

As shown in FIG. 1, a composed email message 22 is sent by the email sender 10, located somewhere on the Internet 12. This message 22 typically uses traditional Simple Mail Transfer Protocol (SMTP), RFC 822 headers and Multipurpose Internet Mail Extension (MIME) body parts to define the format of the mail message. These techniques are all well known to those skilled in the art. The message 22 arrives at the message sever 14 and is normally stored in a message store. Most known messaging systems support a so-called “pull” message access scheme, wherein the mobile device 100 must request that stored messages be forwarded by the message server to the mobile device 100. Some systems provide for automatic routing of such messages which are addressed using a specific email address associated with the mobile device 100. In a preferred embodiment, messages addressed to a message server account associated with a host system such as a home computer or office computer which belongs to the user of a mobile device 100 are redirected from the message server 14 to the mobile device 100 as they are received.

Regardless of the specific mechanism controlling forwarding of messages to mobile device 100, the message 22, or possibly a translated or reformatted version thereof, is sent to wireless gateway 16. The wireless infrastructure 18 includes a series of connections to wireless network 20. These connections could be Integrated Services Digital Network (ISDN). Frame Relay or T1 connections using the TCP/IP protocol used throughout the Internet. As used herein, the term “wireless network” is intended to include three different types of networks, those being (1) data-centric wireless networks, (2) voice-centric wireless networks and (3) dual-mode networks that can support both voice and data communications over the same physical base stations. Combined dual-mode networks include, but are not limited to, (1) Code Divisional Multiple Access (CDMA) networks, (2) the Group Special Mobile or the Global System for Mobile Communications (GSM) and the General Packet Radio Service (GPRS) networks, and (3) future third-generation (3G) networks like Enhanced Data-rates for Global Evolution (EDGE) and Universal Mobile Telecommunications Systems (UMTS). Some older examples of data-centric network include the Mobitex™ Radio Network and the DataTAC™ Radio Network. Examples of older voice-centric data networks include Personal Communication Systems (PCS) networks like GSM, and TDMA systems.

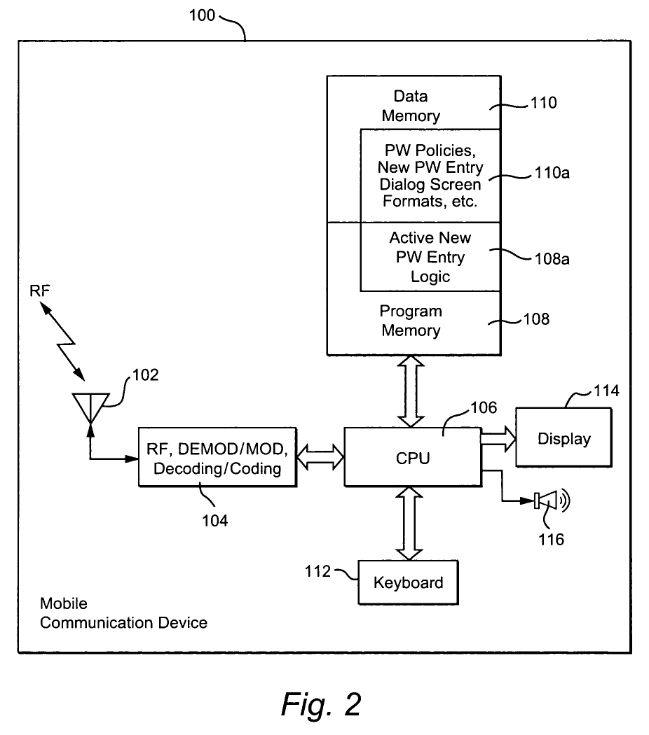

As depicted in FIG. 2, mobile communication device 100 includes a suitable RF antenna 102 for wireless communication to/from wireless network 20. Conventional RF, demodulation/modulation and decoding/coding circuits 104 are provided. As those in the art will appreciate, such circuits can involve possibly many digital signal processors (DSPs), microprocessors, filters, analog and digital circuits and the like. However, since such circuitry is well known in the art, it is not further described.

The mobile communication device 100 will also typically include a main control CPU 106 which operates under control of a stored program in program memory 108 (and which has access to data memory 110). CPU 106 also communicates with a conventional keyboard 112, display 114 (e.g., an LCD) and audio transducer or speaker 116. A portion of data memory 110a is available for storing password policies and entry hints, dialog screen formats and the like. Suitable computer program executable code is stored in portions of program memory 108a to constitute the active new password entry dialog with compact visual indication of adherence to password policy logic and described below.

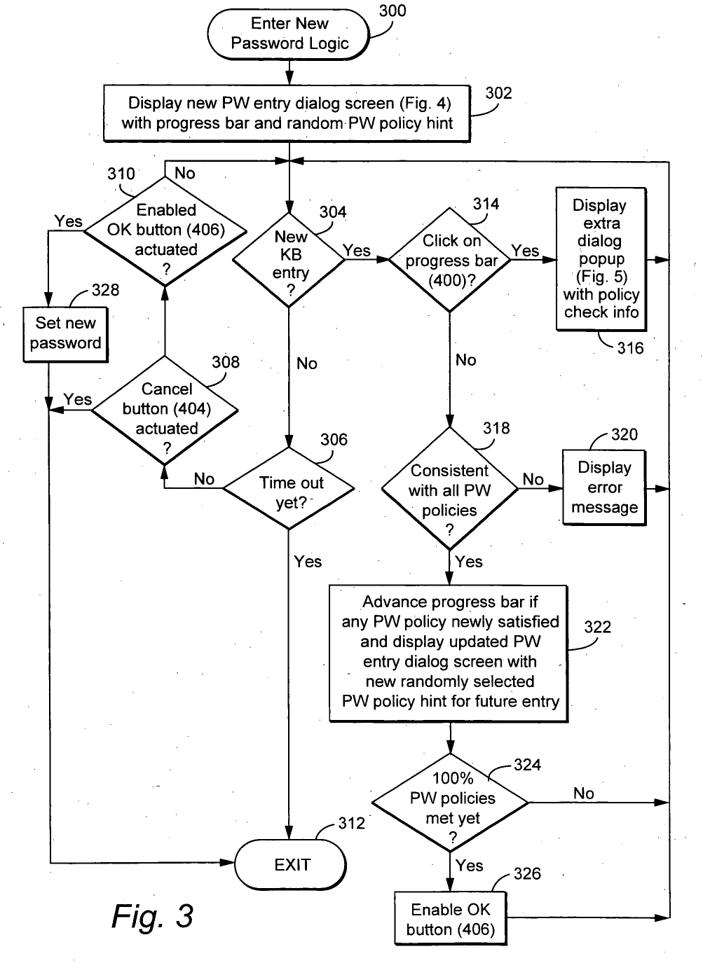

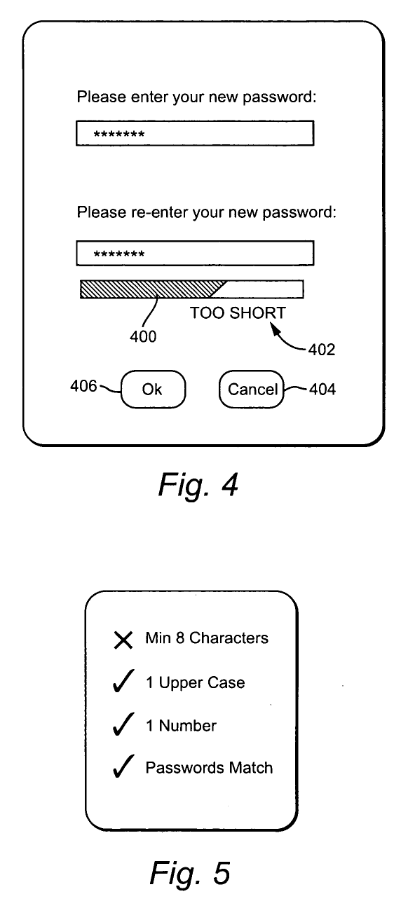

The exemplary enter new password logic is entered at 300 in FIG. 3 (e.g., upon user selection of a conventionally provided option to enter a new password and/or a system-required entry of a new password data). In the exemplary embodiment, a new password entry dialog screen such as that depicted in FIG. 4 is displayed at 302. As will be noted, this exemplary dialog screen in FIG. 4 includes a progress bar 400 and a randomly chosen password policy hint 402 (e.g., text or icon, etc.) that may be conveniently displayed on a limited display area such as that available with a typical handheld wireless communication device. As those in the art will appreciate, the bar graph 400 may include a percentage filling indication as well (e.g., 60%) and/or may be replaced with another compact visual progress indicator or text. Another alternative would involve a color change (i.e., red→yellow→green) or icon change or other detectable feature when it is finished.

At 304, 306, 308 and 310 in FIG. 3, a timed loop is executed looking for a new keyboard entry at 304, time out at 306, cancel button actuation at 308 and an enabled “OK” button actuation at 310. If the “soft” cancel buttons 404, is actuated, then the routine is exited at 312. Otherwise, upon detecting a new keyboard entry at 304, a test is made at 314 to see whether the user has selected progress bar 400. If so, then an extra dialog pop-up display (e.g., as shown in FIG. 5) is displayed at 316 identifying all of the applicable password policies and an indication as to whether each policy has been yet met or unmet (e.g., X and check marks as depicted in FIG. 5).

If the progress bar 400 has not been selected, then a test is made at 318 to ensure that the new keyboard entry is consistent with all password policies. If not, then a suitable error message is displayed at 320 and control is returned to box 304.

If the new keyboard entry has been found consistent with all password policies, then, as depicted at 322, if any additional password policy has now been satisfied, then the progress bar 400 will be suitably updated (along with any textual or numerical percentage completion data) and, in the presently preferred exemplary embodiment, a new randomly selected password policy hint 402 will also be updated on the display screen for future keyboard entries. A test is made at 324 to see if 100% of all applicable password policies have yet been met. If not, then control is returned to 304. If so, then the Ok button is enabled at 326 before control is again returned to box 304.

As those in the art will appreciate, variations and modifications may be made in the above-described exemplary embodiments while yet retaining many of the novel features and advantages of those embodiments. Accordingly, all such variations and modifications are intended to be included within the scope of the appended claims.

What is claimed is:

1. A method for operating a mobile wireless communication device having active new password entry logic, said method comprising:
displaying a new password entry screen which includes
(a) a visual indication of progress toward meeting all applicable password policies that is updated as new password characters are being entered, and
(b) a visual hint associated with at least one applicable password policy that has not yet been satisfied.

2. A method as in claim 1 further comprising:
displaying, upon user command, more detailed password policy screen which identifies applicable password policies and which includes an indication of whether each policy has yet been met or unmet by previously entered new password characters.

3. A method as in claim 1 wherein the displayed hint and associated applicable password policy not yet satisfied is randomly changed during entry of a new password.

4. A method as in claim 1 wherein said new password entry screen is updated after each new password character is entered.

5. A method as in claim 1 wherein said visual indication of progress is presented in a bar chart form.

6. A method as in claim 1 wherein said visual indication of progress is presented as at least one change in color.

7. A method as in claim 1 wherein said visual hint is presented as text reminding the user of an applicable password policy that remains unsatisfied.

8. A mobile wireless communication device having active new password entry logic, said device comprising:
means for displaying a new password entry screen which includes a visual indication of progress toward meeting all applicable password policies that is updated as new password characters are being entered; and
means for also displaying on said screen a visual hint associated with at least one applicable password policy that has not yet been satisfied.

9. A device as in claim 8 further comprising:
means for further displaying upon user command, a more detailed password policy screen which identifies applicable password policies and which includes an indication of whether each policy has yet been met or unmet by previously entered new password characters.

10. A device as in claim 8 wherein the displayed hint and associated applicable password policy not yet satisfied is randomly changed during entry of a new password.

11. A device as in claim 8 wherein said new password entry screen is updated after each new password character is entered.

12. A device as in claim 8 wherein said visual indication of progress is presented in a bar chart form.

13. A device as in claim 8 wherein said visual indication of progress is presented as at least one change in color.

14. A device as in claim 8 wherein said visual hint is presented as text reminding the user of an applicable password policy that remains unsatisfied.

15. A digital storage medium containing a computer program which, when executed, provides a method for operating a mobile wireless communication device having active new password entry logic, said method comprising:
displaying a new password entry screen which includes:
(a) a visual indication of progress toward meeting all applicable password policies that is updated as new password characters are being entered, and
(b) a visual hint associated with at least one applicable password policy that has not yet been satisfied.

16. A digital storage medium as in claim 15 wherein said provided method further comprises:
displaying, upon user command, a more detailed password policy screen which identifies applicable password policies and which includes an indication of whether each policy has yet been met or unmet by previously entered new password characters.

17. A digital storage medium as in claim 15 wherein the displayed hint and associated applicable password policy net yet satisfied is randomly changed during entry of a new password.

18. A digital storage medium as in claim 15 wherein said new password entry screen is updated after each new password character is entered.

19. A digital storage medium as in claim 15 wherein said visual indication of progress is presented in a bar chart form.

20. A digital storage medium as in claim 15 wherein said visual indication of progress is presented as at least one change in color.

21. A digital storage medium as in claim 15 wherein said visual hint is presented as text reminding the user of an applicable password policy that remains unsatisfied.
